(19) United States
(12) Patent Application Publication
(10) Pub. No.: US 2024/0022052 A1
(43) Pub. Date: Jan. 18, 2024

(54) METHOD OF ASSEMBLING CONDUIT SECTIONS

(71) Applicant: S-P Products, Inc., Elk Grove Village, IL (US)

(72) Inventor: Peter A. Vrame, Wood Dale, IL (US)

(21) Appl. No.: 18/204,867

(22) Filed: Jun. 1, 2023

Related U.S. Application Data
(60) Provisional application No. 63/389,090, filed on Jul. 14, 2022.

(51) Int. Cl. H02G 3/04

(52) U.S. Cl. CPC H02G 3/0406

(57) ABSTRACT

A conduit transition coupling facilitates connection of tubing with a conduit section through which associated electrical wiring and/or cables are routed. The assembly method includes providing a conduit transition coupling, which is joined to the conduit section which is positioned in an associated concrete slab or the like. The conduit coupling assembly thus particularly facilitates routing of wiring from a conduit section positioned within a concrete slab or like flooring element, through the conduit transition coupling, and associated conduit or tubing.

### CROSS-REFERENCE TO RELATED APPLICATIONS

This application claims priority of U.S. Provisional Application Ser. No. 63/389,090 filed Jul. 14, 2022, the disclosure of which is hereby incorporated by reference in its entirety.

### FIELD OF THE INVENTION

The present invention relates generally to assembly of conduits, tubing, and like components in a building or other structure, and more particularly to a conduit coupling method which facilitates joining a conduit section to a conduit section positioned in a concrete slab or similar environment. The present invention is directed to a method of joining conduit sections, typically each comprising PVC, such as attendant to damage of one or both of the sections, or for joining the sections for assembly to facilitate wiring or the like to be threaded through the sections. The invention finds applicability in the construction industry, where efficient joining of conduit section is desirable. A transition coupling, having a pair of opposite, tapered end sections, facilitates efficient assembly.

### BACKGROUND OF THE INVENTION

Electrical conduit and related accessories may be made from a variety of materials such as PVC, thin wall metal, heavy wall metal, flexible tubing (MC cable and other types of flexible cable), as well as other materials known to those skilled in the art. Couplings are generally used to connect tubing. In some applications, electrical conduit can be arranged to extend at least partially within a floor structure, such as a concrete slab.

In the course of a typical installation, it may be necessary for electrical workers to provide conduit components which extend from within a concrete slab or like floor element for connection with other components positioned about the concrete slab. Bearing in mind that electrical wiring positioned within the conduit components must be threaded and directed through the various components, it is desirable to provide an arrangement which facilitates assembly of the components, while promoting efficient routing of the associated wiring.

The present invention is directed to conduit coupling method which facilitates assembly of associated tubular structures, with conduit components typically used in conjunction with electrical wiring, with the present invention particularly suited for applications in which a conduit component is positioned in a concrete slab or like flooring structure.

### SUMMARY OF THE INVENTION

The present invention is directed to a method of joining conduit sections, typically each comprising PVC, such as attendant to damage of one or both of the sections, or for joining the sections for assembly to facilitate wiring or the like to be threaded through the sections. The invention finds applicability in the construction industry, where efficient joining of conduit section is desirable. A transition coupling, having a pair of opposite, tapered end sections, facilitates efficient assembly.

A present method of assembling conduit sections comprising the steps of providing first and second cylindrical conduit sections each having an interior surface defining an inside diameter. Each section further includes an exterior surface defining an outside diameter. The inside diameters of the conduit section are the same, and the outside diameters of the conduit sections are the same.

The present method further includes forming a tapered interior end section on the interior surface of each of the conduit sections. Each tapered end section tapers outwardly toward a respective end of the conduit section, and can be formed by suitable reaming.

In accordance with the present invention, a transition coupling having a generally cylindrical configuration is provided for joining the conduit sections to each other. The transition coupling, typically also comprising PVC, has an interior surface extending the length thereof having an inside diameter dimension corresponding to the inside diameters of the conduit sections.

Notably, the transition coupling includes a pair of opposite end portions each have a tapered configuration, tapering inwardly toward the respective end of the transition coupling. A central cylindrical portion, between the tapered end portions, has an outside diameter which is the same as the outside diameter of the conduit sections.

The conduit sections are joined to each other by joining the opposite, tapered end portions of the transition coupling to each of the conduit sections by respectively positioning the tapered end portions of the transition coupling in the tapered interior end sections of the conduit sections. The assembly thus formed has uniform inside and outside diameters to facilitate assembly with related components. The method can be used for a wide variety of conduit sizes, including from 0.5 to 6.0 inches.

Other features and advantages will become readily apparent from the following detailed description, the accompanying drawings, and the appended claims.

### BRIEF DESCRIPTION OF THE DRAWINGS

FIG. 1 is a perspective view of a conduit transition coupling for practice of the present invention; and

FIGS. 2-5 are diagrammatic views illustrating the sequence of steps for of a method forming a couduit coupling assembly in accordance with the present invention.

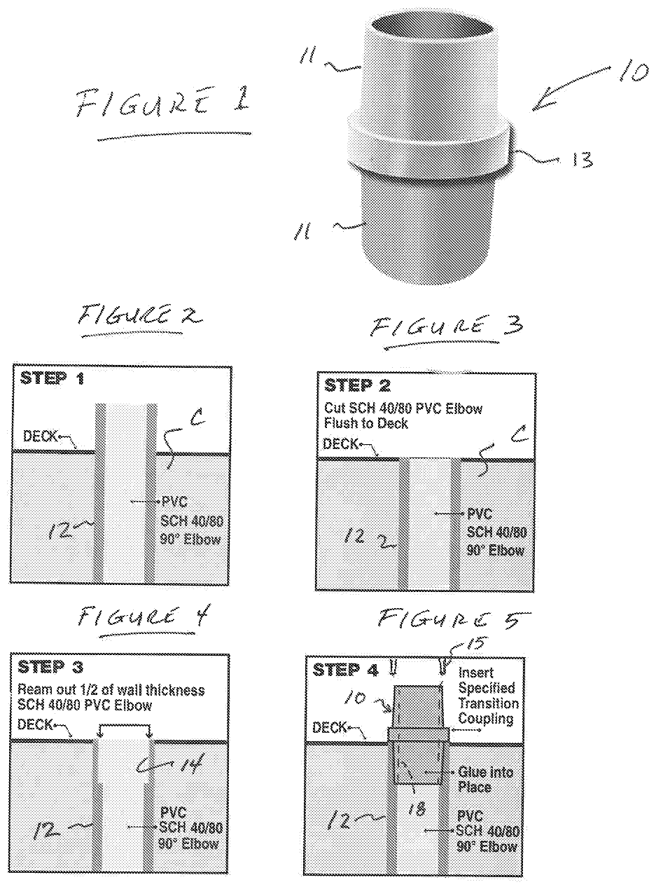

### DETAILED DESCRIPTION

While the present invention is susceptible of embodiment in various forms, there is shown in the drawings and will hereinafter be described a presently preferred embodiment, with the understanding that the present disclosure is intended as exemplification of the invention, and is not intended to limit the invention to the specific embodiment.

The present invention is directed to a method of joining conduit sections, typically each comprising PVC, such as attendant to damage of one or both of the sections, or for joining the sections for assembly to facilitate wiring or the like to be threaded through the sections. The invention finds applicability in the construction industry, where efficient joining of conduit section is desirable. A transition coupling, having a pair of opposite, tapered end sections, facilitates efficient assembly.

A present method of assembling conduit sections comprising the steps of providing first and second cylindrical conduit sections each having an interior surface defining an inside diameter. Each section further includes an exterior surface defining an outside diameter. The inside diameters of the conduit section are the same, and the outside diameters of the conduit sections are the same.

The present method further includes forming a tapered interior end section on the interior surface of each of the conduit sections. Each tapered end section tapers outwardly toward a respective end of the conduit section, and can be formed by suitable reaming.

In accordance with the present invention, a transition coupling 10 having a generally cylindrical configuration is provided for joining the conduit sections to each other. The transition coupling, typically also comprising PVC, has an interior surface extending the length thereof having an inside diameter dimension corresponding to the inside diameters of the conduit sections.

Notably, the transition coupling 10 includes a pair of opposite end portions 11 each have a tapered configuration, tapering inwardly toward the respective end of the transition coupling 10. A central cylindrical portion 13, between the tapered end portions, has an outside diameter which is the same as the outside diameter of the conduit sections.

With reference to the illustrated embodiment, the present invention is directed to use of the transition coupling 10, and a method of installation which particularly facilitates efficient connection of associated tubular conduit components, typically polyvinyl chloride (PVC), wherein one of the sections is positioned in a concrete slab C or like structure. The transition coupling 10 can be used in wet environments, such as in the area of cooling towers in date centers. Connection from concrete pads to various heating, ventilation and air conditioning equipment is facilitated.

In accordance with the present invention, the present method of forming a coupling assembly comprises the steps of providing a conduit 12, typically formed from polyvinyl chloride (PVC) in the associated building slab C or like structure so that the conduit projects 12 from the surface of the slab, as shown in Step 1.

As shown in Step 2, the present method includes cutting a portion of the conduit 12 which projects above the surface of the slab C to prepare the conduit for connection.

As shown in Step 3, the present method next contemplates cutting the conduit 12 at an inside surface thereof to form a connection region 14, which is preferably tapered inwardly in a direction away from the conduit opening, i.e., downwardly and inwardly in the illustrated embodiment. This step is preferably effected by reaming the interior surface of the conduit 12 to provide an inner surface at 14 for assembling the components of the present assembly.

Next, the conduit transition coupling 10, configured in accordance with the present invention, is provided, with the coupling 10 inserted into the conduit 12 in the tapered, connection region 14 of the conduit. The transition coupling 10 is preferably formed for PVC for economical and durable service. The exterior of the coupling is provided with tapered surfaces 11 which are complementary to the tapered, connection region 14 of the conduit 12. Industrial grade adhesive is provided to securely and permanently adhere the transition coupling 10 to the conduit 12. Step 4 shows this step of the process, with the conduit coupling 10 illustrated joined to the conduit 12. As illustrated, the inside diameter of the coupling 10, as shown in phantom line at 18, can be the same as the inside diameter of conduit 12 to facilitate the smooth passage of wiring through the assembled components.

The present coupling assembly is completed by joining the transition coupling 10 to an associated conduit or tubing 15 positioned exteriorly of the slab C. As with conduit section 12, the inside surface of the conduit section 15 is tapered to complement to taper of the portions 11 of the transition coupling 10. Adhesive applied to the complementary tapered portions secures them to each other.

Thus, the conduit sections 12, 15 are joined to each other by joining the opposite, tapered end portions 11 of the transition coupling 10 to each of the conduit sections by respectively positioning the tapered end portions of the transition coupling 10 in the tapered interior end sections of the conduit sections 12, 15. The assembly thus formed has uniform inside and outside diameters to facilitate assembly with related components. The method can be used for a wide variety of conduit sizes, including from 0.5 to 6.0 inches.

As will be appreciated from the above description, the exact order in which components of the present assembly are joined to each other and assembled can be varied in accordance with the requirements of any specific application.

From the foregoing, it will be observed that numerous modifications and variations of the present invention can be effected without departing from the true spirit and scope of the novel concept of the present invention. It is to be understood that no limitation with respect to the specific embodiment illustrated herein is intended or should be inferred. The disclosure is intended to cover by the appended claims all such modifications as fall within the scope of the claims.

1. A method of assembling conduit sections, comprising the steps of:
providing first and second cylindrical conduit sections each having an interior surface defining an inside diameter, and an exterior surface defining an outside diameter, wherein said inside diameters of said conduit section are the same, and said outside diameters of said conduit sections are the same;
forming a tapered interior end section on the interior surface of each of said conduit sections, wherein each tapered end section tapers outwardly toward a respective end of said conduit section;
providing a transition coupling having a generally cylindrical configuration, said transition coupling having an interior surface extending the length thereof having an inside diameter dimension corresponding to said inside diameters of said conduit sections,
said transition coupling having a pair of opposite end portions each have a tapered configuration tapering inwardly toward the respective end of the transition coupling, and a central cylindrical portion between said end portions having an outside diameter the same as said outside diameters of said conduit sections; and
joining said conduit sections to each other by joining the opposite end portions of said transition coupling to each of said conduit sections by respectively positioning said tapered end portions of said transition coupling in said tapered interior end sections of said conduit sections.

2. A method of forming a coupling assembly in accordance with claim 1, including
cutting each said conduit section at the inside surface thereof by reaming each said conduit section.

3. A method of forming a coupling assembly in accordance with claim 2, including
cutting each said conduit section at the inside surface thereof at a taper.

4. A method of forming a coupling assembly in accordance with claim 1, wherein
said transition coupling comprises polyvinyl chloride.
